(19) United States
(12) Patent Application Publication
(10) Pub. No.: US 2011/0297194 A1
(43) Pub. Date: Dec. 8, 2011

(54) CLEANING SYSTEM

(75) Inventor: BERND HANSEN, Rantrum (DE)

(73) Assignee: KRONES AG, Neutraubling (DE)

(21) Appl. No.: 13/151,341

(22) Filed: Jun. 2, 2011

(30) Foreign Application Priority Data
Jun. 2, 2010 (DE) 102010029641.4

(51) Int. Cl. B08B 9/00

(52) U.S. Cl. 134/137

(57) ABSTRACT

A cleaning system for bottles, including a housing in which at least one transport element having bottle carriers conveys the bottles through different system zones, where at least one sheet-metal wall is provided in the housing as a boundary of the bottle transport path. The sheet-metal wall can be contacted on a bottle contact side by bottles in at least one locally defined wear portion along the bottle transport path, and at least one wear plate is exchangeably arranged in the wear portion of the sheet-metal wall.

### CROSS-REFERENCE TO RELATED APPLICATION

The present application claims the benefit of priority of German Application No. DE102010029641.4, filed Jun. 2, 2010. The entire text of the priority application is incorporated herein by reference in its entirety.

### FIELD OF THE DISCLOSURE

The present disclosure relates to a cleaning system of the typeused for cleaning bottles in beverage bottling operations.

### BACKGROUND

In conventional cleaning systems, particularly for glass and/or plastic bottles, the bottles are inserted e.g. in transverse rows into bottle carriers, the bottle carriers being fastened one after the other to at least one surrounding transport chain. For instance, up to 74 bottles or more are conveyed side by side in successive transverse rows in a relatively close arrangement through different zones in the cleaning system, namely along partly arcuate tracks. Even if the bottles are held in the bottle carriers, the contact e.g. of the bottle bottom with the contact top side of the sheet-metal wall causes mutual wear. Especially in at least one dome-shaped deflection zone along the bottle transport path a significant wear portion is noticed in the bottle paths since each bottle in the bottle carrier performs a tilting movement during deflection and is put into an inclined position in a locally concentrated form with the bottle bottom on the bottle contact side. The local wear is all the more pronounced the more dirt and sand has been introduced into the cleaning system. Since each bottle in the deflection zone tilts virtually at the same place, a significant, clearly visible and noticeable notch in the bottle contact side of the sheet-metal wall is evolving at said place over time. The quality of the bottle bottom has a great influence on the wear characteristics. If the material wear is very advanced on the sheet-metal wall, the bottles get more and more damaged. In the case of glass bottles, the breakage of glass further intensifies the gradual destruction of the sheet-metal wall. The cleaning system must then be repaired. For this purpose the sheet-metal wall is removed completely, e.g. in sections, and a new sheet-metal wall or new sheet-metal sections are welded in. This repair can only be carried out by specifically trained experts in housing construction and necessitates a long down time of the cleaning system.

### SUMMARY OF THE DISCLOSURE

It is one aspect of the present disclosure to provide a cleaning system of the aforementioned type in which such repair work due to wear can be carried out in an easy and fast way.

Since the at least one exchangeably arranged wear plate is provided in the wear portion, the repair work can be carried out easily and rapidly just by exchanging the worn wear plate. The sheet-metal wall is used further at least at the beginning. The repair work can be carried out without any problems even by untrained persons, and it just necessitates a short down time of the cleaning system. Since the repair can be carried out easily and rapidly, it can be performed earlier than in former times so as to minimize damage to the bottles, which can thus circulate more often according to the return or recycling principle. This also reduces the use of new bottles during recycling.

In an expedient embodiment the wear plate is exchangeably fixed in the wear portion by screws. The screws have just to be unscrewed for repair and, after the wear plate has been replaced by a new one, they have just to be tightened again. This requires only relatively untrained personnel, and the down time of the cleaning system is also relatively short.

The respective wear plate could be engaged alternatively or additively for screwing or it could be fixed by means of detachable locks.

For easier handling and since wear may vary in the transverse direction of the wear portion, i.e. in a direction transverse to the bottle transport direction, it is expedient when in the wear portion a plurality of individually exchangeable wear plates are provided side by side, preferably butt-jointed to one another. This makes it possible to exchange only a particularly strongly worn wear plate and to further use other plates in the wear portion. Alternatively, a for instance strip-shaped space could be provided between two wear plates, said space being preferably aligned with a gap between bottle paths where there is hardly any wear. Even if in case of repair all wear plates are exchanged in the wear portion, the subdivision into a plurality of wear plates simplifies handling during repair. Similarly, more than only one wear plate could be exchangeably arranged in bottle transport direction in the wear portion. It would alternatively be possible to mount a separate wear plate to be individually exchangeable in each bottle path defined in the cleaning system.

In an expedient embodiment each wear plate is a sheet-metal strip with rectangular or square outer contour. Screw holes for the screws are expediently placed along the outer contour of the sheet-metal strip. Due to the great number of screw holes distributed along the outer contour one obtains a fun closure of the mounted wear plate in the wear portion. This, however, is not meant to exclude a situation where the wear plates are given contour shapes, optionally adapted to the conditions in the wear portion, that differ from a rectangle or square, e.g. an oval shape or a rectangular shape with corrugated edges, or the like. Expediently, the screws are screwed for easier repair handling from the bottle contact side into the wear plate and with a mounting positioned thereunder e.g. of the sheet-metal wall itself. Alternatively or additively the screws could also be introduced from the opposite side. At any rate it is expedient to place the screws flush with the contact top side, optionally slightly countersunk relative to the bottle contact side. Other locks could similarly also be used for fixing purposes, e.g. also locks that are only anchored in the sheet-metal wall or/and in a holder.

In an expedient embodiment the wear plate is more wear resistant than neighboring portions of the sheet-metal wall so as to take into account the locally stronger wear in the wear portion. For instance the wear plates are made of a material of a higher quality, e.g. a sheet-metal material, e.g. of high quality steel, than the adjoining sheet-metal wall.

In another alternative the wear plate has at least a more wear-resistant bottle contact side than the area of the sheet-metal wall adjacent to the wear plate, e.g. a coating, surface refinement, or the like.

In one embodiment the wear portion of the sheet-metal wall in an arcuate bottle deflection zone of the housing, e.g. in a dome-shaped or depression-shaped deflection zone, comprises a bottle contact side facing the bottles, which is convexly or concavely curved, for instance for bottle bottoms. The wear plate which is exchangeably mounted there is a correspondingly bent sheet-metal strip, optionally a prefabricated spare part which is also delivered by the manufacturer to the user of the cleaning system or a spare part produced on site. This, however, is not to exclude a situation where at least one wear plate is provided in an at least substantially flat wear portion, for instance in a section of the bottle transport path in which locally strong wear must be expected for other reasons, e.g. in a curve or at a place where more abrasive soiling occurs during cleaning.

In a further embodiment the bottle deflection zone extends in a direction transverse to the transport direction of bottles conveyed in transverse rows and, in the wear portion, wear plates of the same width with the same or different lengths in a direction transverse to the transport direction are arranged in a direction transverse to the transport direction one after the other and in an individually exchangeable way. Identical lengths simplify the manufacture due to an identical part principle.

In a further embodiment the sheet-metal wall is configured to be continuous in transport direction, and the wear plate is screwed onto the sheet-metal wall. The continuous sheet-metal wall ensures tightness to cleaning media and acts as a stable carrier of each wear plate.

It may here be expedient when the wear plate edges positioned in transport direction at the front and/or rear are beveled to ensure smooth transitions.

In a further embodiment the sheet-metal wall has at least one respective local recess matched to the wear plate thickness for the flush insertion of at least one wear plate. The sheet-metal wall may here be a sheet-metal edge part. The wear wall mounted in the recess avoids objectionable transitions during transportation of the bottles over the wear portions. Alternatively, a section framed e.g. at the rear side could be provided in the sheet-metal wall for this purpose, and a possibly necessary seal could even be formed therein with the non-rotated wear plate.

Finally, it may be expedient that the bottles in each transverse row are conveyed spaced apart from one another with gaps, and the screws of the exchangeably arranged wear plate are aligned with the gaps between the bottles. This avoids collisions causing wear between the bottles and the screws or screw holes.

### BRIEF DESCRIPTION OF THE DRAWINGS

The subject matter of the disclosure shall now be explained with reference to the drawing, in which:

FIG. 1 shows a section of a cleaning system for bottles in a perspective illustration; and

FIG. 2 shows an enlarged section of a front view with respect to FIG. 1.

### DETAILED DESCRIPTION OF THE PREFERRED EMBODIMENT

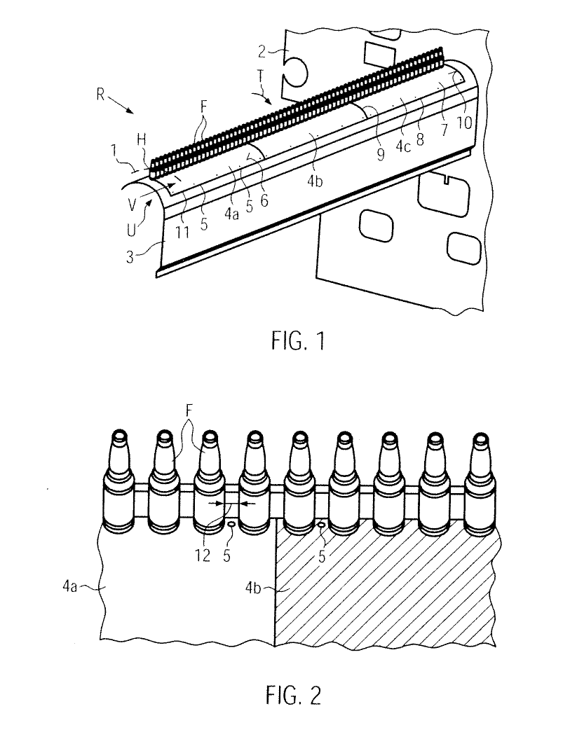

FIG. 1 is a perspective view showing a section (a system zone) of a cleaning system R for bottles F, particularly for glass and/or plastic bottles. Such cleaning systems R (bottle washing machines) are predominantly used in the beverage filling industry either for newly produced bottles or for used bottles circulated according to the return or recycling principle.

The cleaning system R comprises a housing 2 in which a sheet-metal wall 3 forms a boundary for a bottle transport path through system zones of the cleaning system R, e.g., as shown, in a system zone with a deflection zone U which is dome-shaped, i.e. arcuately convexly curved, in bottle transport direction T and which has a dome crest oriented e.g. in a direction transverse to the transport direction T. The bottles F are e.g. arranged in bottle carriers H. The bottle carriers H are conveyed by at least one transport element 1, e.g. a conveyor chain, in transport direction T through the cleaning system 2. In the illustrated embodiment successive transverse rows of the bottles F are also conveyed over the deflection zone U. The bottles F can contact the sheet-meal wall 3 at least sometimes, for instance with their bottle bottoms, but lastingly contact the wall in the deflection zone U, which thereby constitutes a wear portion V in which locally strong wear has to be expected along the bottle transport path. The reason for this is that upon deflection in the deflection zone U each bottle can perform a relative tilt movement in the bottle carrier H virtually at the same place of the wear portion V, in which tilt movement the bottle bottom, for instance, lastingly contacts the bottle contact side in the wear portion V, resulting in a significant material removal at said place over time. Such a wear portion V can also or only be expected in a concave depression and/or in a flat section, possibly even only at one place or a plurality of places located side by side or one after the other.

To simplify the repair work required because of such a wear, to shorten the repair time and to reduce the efforts in terms of material and work for the repair, at least one wear plate 4a, 4b 4c is exchangeably arranged according to the disclosure in the and/or in the respective wear portion V or at least at a wear-sensitive place.

Expediently, as outlined in FIG. 1, even a plurality of wear plates 4a, 4b, 4c are exchangeably mounted individually or jointly, substantially over the width of the wear portion V, preferably in a butt joint or at strip-like intervals, e.g. aligned with respect to gaps between given bottle paths. For the fixation of each wear plate 4a, 4b, 4c different fastening elements or locks may be used. Expediently, the fastening elements are screws 5 which are screwed in or through screw holes 6 of the wear plates 4a, 4b, 4c either from the bottle contact side and/or from the opposite side and in transport structures positioned behind, or the sheet-metal wall 3, or abutments arranged or fixed there, such as nuts. The tightened screws 5 are flush with the bottle contact side or are even countersunk. The screw bores 6 may be smooth bores or threaded bores, e.g. if the wear plate is screwed from the rear side through the sheet-metal wall 3. In the embodiment shown in FIG. 1, each wear plate 4a, 4b, 4c is screwed onto the upper side of the sheet-metal wall 3. Each wear plate 4a, 4b, 4c is e.g. a rectangular (or square or otherwise shaped) sheet-metal strip 7; in the illustrated embodiment with edges 8 positioned at the front and rear in transport direction T and straight side edges 9, 10. At least the edges 8 positioned at the front and rear may be beveled. Alternatively, a recess 11 which is matched to the wear plate thickness and into which each wear plate 4a, 4b, 4c is inserted to be flush therewith so as to avoid objectionable transitions could be formed in the wear portion V. Alternatively or in addition to the fastening elements each wear plate 4a, 4b, 4c may be engaged or fixed by means of detachable locks of any types. For instance, strong permanent magnets could serve as magnetic locks, or suction cups, or the like.

As outlined in FIG. 2 in a front view, the bottles F can be conveyed mutually spaced apart with gaps 12. Expediently, screws 5 are aligned with the gaps 12 to rule out objectionable collisions or collisions causing wear, for instance for the bottle bottoms.

Each wear plate 4a, 4b, 4c can be made from a more wear-resistant material, particularly sheet-metal material, than portions of the sheet-metal wall 3 adjacent to the wear plate. The wear plate of higher quality, which might be expensive, increases the total costs only insignificantly because it occupies only a relative small sub-portion in the sheet-metal wall. Alternatively, at least the bottle contact side of the wear plate could be made more wear-resistant, with a lining, a coating, or by way of a special surface treatment, than portions of the sheet-metal wall adjacent to the wear plate. The advantage of the simple and less expensive repair is thereby combined with a longer service life or a lower repair frequency.

The arrangement of a plurality of wear plates of the same size or of different sizes in a direction transverse to or in bottle transport direction T results not only in simplified handling during repair, but makes it also possible to exchange only a strongly worn wear plate and to leave others for the time being. This, however, should not rule out that a wear plate extending over the total width of the sheet-metal wall at the most is exchangeably provided or/and more than one wear plate is exchangeably arranged in the wear portion V in transport direction.

Prefabricated and optionally correspondingly fittingly bent wear plates, e.g. for a plurality of system zones of the cleaning system that are critical with respect to wear can expediently be stored at the place of use of the cleaning system so as to carry out repairs at any time, if necessary, for instance by the personnel of the user of the cleaning system.

1. A cleaning system (R) for bottles (F), particularly glass and/or plastic bottles, comprising a housing in which at least one transport element comprising bottle carriers (H) conveys the bottles (F) through different system zones, at least one sheet-metal wall is provided in the housing as a boundary of the bottle transport path, which sheet-metal wall can be contacted on a bottle contact side by bottles at least in at least one locally defined wear portion (V) along the bottle transport path, and at least one exchangeably arranged wear plate which in the wear portion (V) defines the bottle contact side of the sheet-metal wall is provided in the wear portion (V) of the sheet-metal wall.

2. The cleaning system according to claim 1, wherein the wear plate is exchangeably fixed with screws in the wear portion (V).

3. The cleaning system according to claim 1, wherein the wear plate is one of engaged, fixed or a combination thereof with detachable locks in the wear portion (V).

4. The cleaning system according to claim 1, wherein in the wear portion (V) a plurality of individually exchangeable wear plates are provided side by side.

5. The cleaning system according to claim 1, wherein the wear plate is a sheet-metal strip with one or a rectangular or square outer contour.

6. The cleaning system according to claim 18, wherein the screws or locks are introduced from the bottle contact side and/or from the side facing away from the bottle contact side, into the wear plate and a support structure positioned behind, and/or the sheet-metal wall.

7. The cleaning system according to claim 1, wherein the wear plate is more wear-resistant than portions of the sheet-metal plate adjacent to the wear plate.

8. The cleaning system according to claim 1, wherein the wear plate has a more wear-resistant bottle contact side than portions of the sheet-metal wall adjacent to the wear plate.

9. The cleaning system according to claim 1, wherein the wear portion (V) of the sheet-metal wall, in a dome- or depression-shaped arcuate bottle deflection zone (U) of the housing, has a convexly or concavely curved bottle contact side that faces the bottles and is intended for bottle bottoms, and that the respective wear plate is a sheet-metal strip bent with a fitting curvature.

10. The cleaning system according to claim 1, wherein the wear plate is arranged in a wear portion (V) of the bottle transport path that is at least substantially flat.

11. The cleaning system according to claim 9, wherein the dome- or depression-shaped bottle deflection zone (U) extends in a direction transverse to a transport direction (T) of bottles (F) conveyed in transverse rows, and that in the wear portion (V) a plurality of wear plates of the same width in a direction transverse to the transport direction (T) with the same or different lengths are arranged in a direction transverse to the transport direction (T) one after the other and in an individually exchangeable way.

12. The cleaning system according to claim 1, wherein the sheet-metal wall is configured to be continuous in a transport direction (T), and that the wear plate is screwed onto the sheet-metal wall.

13. The cleaning system according to claim 1, wherein wear plate edges are positioned at the front and/or rear in a transport direction (T) and are beveled.

14. The cleaning system according to claim 1, wherein at the sheet-metal wall has a respective local recess (11) matched to the wear plate thickness, or a section framed at the underside for the flush insertion of at least one wear plate.

15. The cleaning system according to claim 1, wherein bottles (F) in each transverse row are conveyed spaced apart from one another with gaps along given bottle paths, and that screws or locks for fixing the wear plate are aligned with the gaps between the bottles (F).

16. The cleaning system of claim 4, wherein the plurality of individually exchangeable wear plates are provided in butt-jointed fashion or at intervals.

17. The cleaning system of claim 16, wherein when provided at intervals the plurality of wear plates are placed next to the bottle paths.

18. The cleaning system of claim 5, and wherein along the outer contour are anchoring points for screws or locks.

19. The cleaning system of claim 18, wherein the anchoring points are one of bores, threaded bores or abutements.

20. The cleaning system of claim 6, wherein the sheet-metal wall is flush with the bottle contact side.

21. The cleaning system of claim 7, wherein the wear plate consists of more wear-resistant sheet-metal material than the portion of the sheet-metal plate.
